(19) United States
(12) Patent Application Publication
(10) Pub. No.: US 2011/0170253 A1
(43) Pub. Date: Jul. 14, 2011

(54) HOUSING ASSEMBLY FOR IMAGING ASSEMBLY AND FABRICATION METHOD THEREFOR

(75) Inventors: Ning Liu, Calgary (CA); Zoran Nesic, Calgary (CA); Alex Chtchetinine, Calgary (CA)

(73) Assignee: SMART Technologies ULC, Calgary (CA)

(21) Appl. No.: 12/709,419

(22) Filed: Feb. 19, 2010

Related U.S. Application Data
(60) Provisional application No. 61/294,827, filed on Jan. 13, 2010.

(51) Int. Cl. G06F 1/16; B29C 45/14

(52) U.S. Cl. 361/679.22; 264/250

(57) ABSTRACT

A housing assembly for an imaging assembly comprises a housing body comprising at least one passage for accommodating a respective light socket; and a filter integrated with the housing body through which an image sensor looks.

### CROSS-REFERENCE TO RELATED APPLICATIONS

This application claims the benefit of U.S. Provisional Application No. 61/294,827 to Liu, et al., filed on Jan. 13, 2010, entitled “HOUSING ASSEMBLY FOR INTERACTIVE INPUT SYSTEM AND FABRICATION METHOD”, the content of which is incorporated herein by reference in its entirety.

### FIELD OF THE INVENTION

The present invention relates generally to interactive input systems, and in particular to a housing assembly for an imaging assembly and to a fabrication method therefor.

### BACKGROUND OF THE INVENTION

Interactive input systems that allow users to inject input (e.g., digital ink, mouse events, etc.) into an application program using an active pointer (e.g., a pointer that emits light, sound or other signal), a passive pointer (e.g., a finger, cylinder or other object) or other suitable input device such as for example, a mouse or trackball, are well known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; 7,274,356; and 7,532,206 assigned to SMART Technologies ULC of Calgary, Alberta, Canada, assignee of the subject application, the contents of which are incorporated by reference in their entirety; touch systems comprising touch panels employing electromagnetic, capacitive, acoustic or other technologies to register pointer input; tablet personal computers (PCs); laptop PCs; personal digital assistants (PDAs); and other similar devices.

Above-incorporated U.S. Pat. No. 6,803,906 to Morrison, et al., discloses a touch system that employs machine vision to detect pointer interaction with a touch surface on which a computer-generated image is presented. A rectangular bezel or frame surrounds the touch surface and supports digital imaging devices at its corners. The digital imaging devices have overlapping fields of view that encompass and look generally across the touch surface. The digital imaging devices acquire images looking across the touch surface from different vantages and generate image data. Image data acquired by the digital imaging devices is processed by on-board digital signal processors to determine if a pointer exists in the captured image data. When it is determined that a pointer exists in the captured image data, the digital signal processors convey pointer characteristic data to a master controller, which in turn processes the pointer characteristic data to determine the location of the pointer in (x,y) coordinates relative to the touch surface using triangulation. The pointer coordinates are conveyed to a computer executing one or more application programs. The computer uses the pointer coordinates to update the computer-generated image that is presented on the touch surface. Pointer contacts on the touch surface can therefore be recorded as writing or drawing or used to control execution of application programs executed by the computer.

U.S. Pat. No. 7,532,206 to Morrison, et al., discloses a touch system and method that differentiates between passive pointers used to contact a touch surface so that pointer position data generated in response to a pointer contact with the touch surface can be processed in accordance with the type of pointer used to contact the touch surface. The touch system comprises a touch surface to be contacted by a passive pointer and at least one imaging device having a field of view looking generally across the touch surface. At least one processor communicates with the at least one imaging device and analyzes images acquired by the at least one imaging device to determine the type of pointer used to contact the touch surface and the location on the touch surface where pointer contact is made. The determined type of pointer and the location on the touch surface where the pointer contact is made are used by a computer to control execution of an application program executed by the computer.

U.S. Pat. Nos. 6,335,724 and 6,828,959 to Takekawa, et al., disclose a coordinate-position input device having a frame with a reflecting member for recursively reflecting light provided in an inner side from four edges of the frame forming a rectangular form. Two optical units irradiate light to the reflecting member and receive the reflected light. With the mounting member, the frame can be detachably attached to a white board. The two optical units are located at both ends of any one of the frame edges forming the frame, and at the same time the two optical units and the frame body are integrated to each other.

Certain models of interactive whiteboards sold by SMART Technologies ULC of Calgary, Alberta, Canada under the name SMARTBoard™, that employ machine vision technology to register pointer input, make use of imaging assemblies that have housing assemblies, each comprising a window pane covering an imaging sensor, and where the window pane acts as a filter to visible light. For example, U.S. Patent Application Publication No. 2009/0278795 to Hansen, et al., assigned to SMART Technologies ULC discloses one such housing assembly. Although this housing assembly design is satisfactory, improvements that provide enhanced performance with regard to pointer imaging and which enable less costly fabrication are desired.

It is therefore an object of the present invention at least to provide a novel housing assembly for an imaging assembly and a novel fabrication method therefor.

### SUMMARY OF THE INVENTION

Accordingly, in one aspect there is provided a housing assembly for an imaging assembly of an interactive input system, the housing assembly comprising a housing body comprising at least one passage for accommodating a respective light socket; and a filter integrated with the housing body through which an image sensor looks.

In one embodiment, the housing body comprises a plurality of passages, each passage accommodating a respective light socket. Two of the passages are positioned on opposite sides of the filter and one of the passages is positioned above the filter. The filter is an infrared pass filter.

In one embodiment, the housing assembly further comprises a retro-reflective label disposed on a forward surface of the housing body. The socket comprises a closed end through which radiation emitted by a light source accommodated by the socket passes. The closed end comprises at least one of a beam splitter layer and a diffuser layer. The socket is rotatable within the passage between indexed positions. In this case, the socket and passage carry mating formations such as for example, grooves formed in a wall surrounding the passage and a rib carried by the socket.

In another aspect, there is provided a method of fabricating a housing assembly of an imaging assembly for use with an interactive input system, the method comprising forming a filter in a mold using a first injection; and forming a housing body around the filter in the mold using a second injection.

In one embodiment, the method further comprises resetting the mold prior to the step of forming the housing body. The filter forming comprises molding the filter using a first material and the housing body forming comprises molding the housing body using a second material. The method may further comprise applying a label to the forward surface of the housing body.

### BRIEF DESCRIPTION OF THE DRAWINGS

Embodiments will now be described more fully with reference to the accompanying drawings in which:

FIG. 1 is a schematic, partial perspective view of an interactive input system.

FIG. 2 is a block diagram of the interactive input system of FIG. 1.

FIG. 3 is a block diagram of an imaging assembly forming part of the interactive input system of FIG. 1.

FIG. 4 is a block diagram of a master controller forming part of the interactive input system of FIG. 1.

FIGS. 5a and 5b are front and rear perspective views of a housing assembly forming part of the imaging assembly of FIG. 3.

FIG. 6 is an exploded perspective view of the housing assembly of FIGS. 5a and 5b.

FIGS. 7a and 7b are rear perspective and cross-sectional views, respectively, of a light source socket for use with the housing assembly of FIGS. 5a and 5b.

FIGS. 8a and 8b are perspective and side cross-sectional views, respectively, of a portion of the light source socket of FIGS. 7a and 7b.

FIG. 9 is a cross-sectional view of the light source socket of FIGS. 7a and 7b, showing a light transmission pattern.

FIGS. 10a and 10b are schematic front views of the light source socket of FIGS. 7a and 7b showing different orientations of a beam splitter layer.

FIG. 11a is a simplified exemplary image frame captured by the imaging assembly of FIG. 3 when IR LEDs associated when other imaging assemblies of the interactive input system are in an off state.

FIG. 11b is a simplified exemplary image frame captured by the imaging assembly of FIG. 3 when IR LEDs associated when other imaging assemblies of the interactive input system are in a low current state.

FIG. 12 is a flowchart showing the steps performed during fabrication of the housing assembly of FIGS. 5a and 5b.

FIGS. 13a to 13c are top plan views of a mold platen used during fabrication of the housing assembly of FIGS. 5a and 5b, at different stages during the fabrication process.

### DETAILED DESCRIPTION OF THE EMBODIMENTS

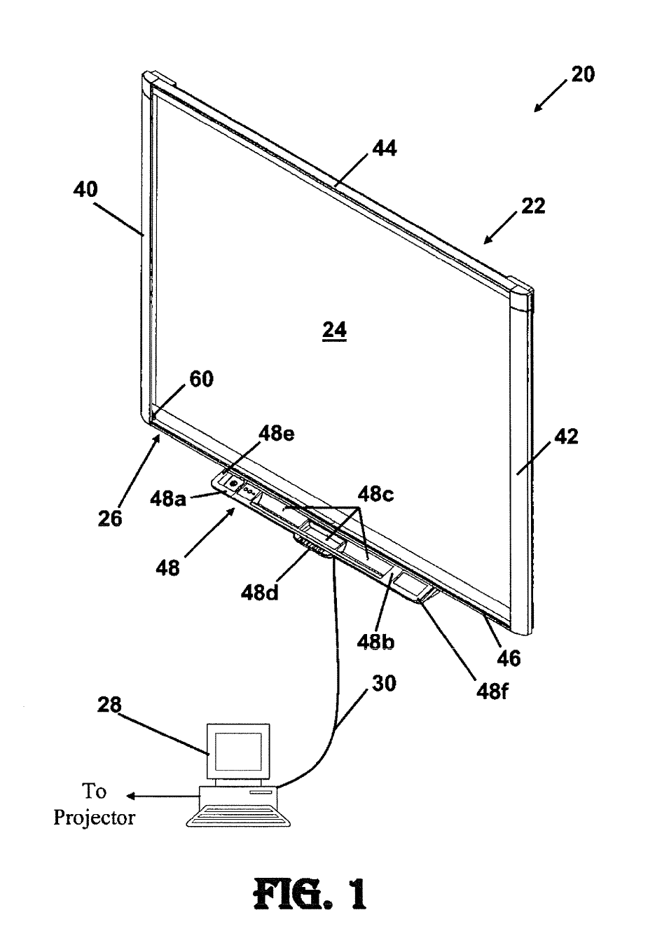

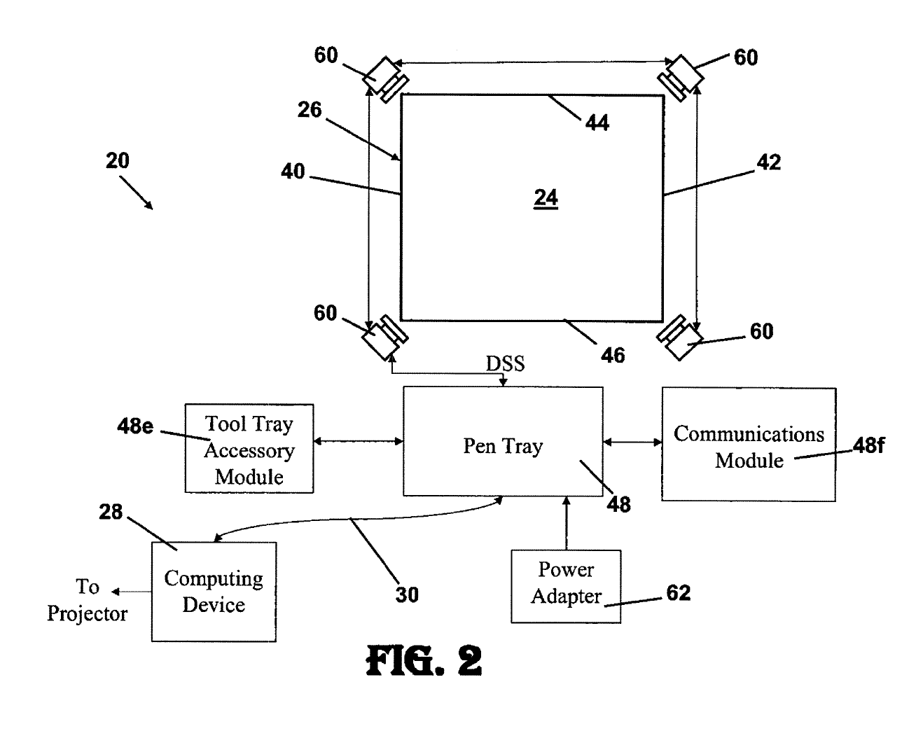

Turning now to FIGS. 1 and 2, an interactive input system that allows a user to inject input such as digital ink, mouse events etc. into an application program executed by a computing device is shown and is generally identified by reference numeral 20. In this embodiment, interactive input system 20 comprises an interactive board 22 mounted on a vertical support surface such as for example, a wall surface or the like. Interactive board 22 comprises a generally planar, rectangular interactive surface 24 that is surrounded about its periphery by a bezel 26. An ultra-short throw projector (not shown) such as that sold by SMART Technologies ULC under the name Miata™ is also mounted on the support surface above the interactive board 22 and projects an image, such as for example a computer desktop, onto the interactive surface 24.

The interactive board 22 employs machine vision to detect one or more pointers brought into a region of interest in proximity with the interactive surface 24. The interactive board 22 communicates with a general purpose computing device 28 executing one or more application programs via a universal serial bus (USB) cable 30. General purpose computing device 28 processes the output of the interactive board 22 and adjusts image data that is output to the projector, if required, so that the image presented on the interactive surface 24 reflects pointer activity. In this manner, the interactive board 22, general purpose computing device 28 and projector allow pointer activity proximate to the interactive surface 24 to be recorded as writing or drawing or used to control execution of one or more application programs executed by the general purpose computing device 28.

The bezel 26 in this embodiment is mechanically fastened to the interactive surface 24 and comprises four bezel segments 40, 42, 44, 46. Bezel segments 40 and 42 extend along opposite side edges of the interactive surface 24 while bezel segments 44 and 46 extend along the top and bottom edges of the interactive surface 24 respectively. In this embodiment, the inwardly facing surface of each bezel segment 40, 42, 44 and 46 comprises a single, longitudinally extending strip or band of retro-reflective material. To take best advantage of the properties of the retro-reflective material, the bezel segments 40, 42, 44 and 46 are oriented so that their inwardly facing surfaces extend in a plane generally normal to the plane of the interactive surface 24.

A tool tray 48 is affixed to the interactive board 22 adjacent the bezel segment 46 using suitable fasteners such as for example, screws, clips, adhesive etc. As can be seen, the tool tray 48 comprises a housing 48a having an upper surface 48b configured to define a plurality of receptacles or slots 48c. The receptacles 48c are sized to receive one or more pen tools as well as an eraser tool that can be used to interact with the interactive surface 24. Control buttons 48d are provided on the upper surface 48b of the housing 48a to enable a user to control operation of the interactive input system 20. One end of the tool tray 48 is configured to receive a detachable tool tray accessory module 48e while the opposite end of the tool tray 48 is configured to receive a detachable communications module 48f for remote device communications. Further specifics concerning the tool tray 48 are described in U.S. Provisional Application Ser. No. 61/294,831 to Bolt, et al., entitled “INTERACTIVE INPUT SYSTEM AND TOOL TRAY THEREFOR” filed on Jan. 13, 2010, the content of which is incorporated herein by reference in its entirety.

Imaging assemblies 60 are accommodated by the bezel 26, with each imaging assembly 60 being positioned adjacent a different corner of the bezel. The imaging assemblies 60 are oriented so that their fields of view overlap and look generally across the entire interactive surface 24. In this manner, any pointer such as for example a user's finger, a cylinder or other suitable object, or a pen or eraser tool lifted from a receptacle 48c of the tool tray 48, that is brought into proximity of the interactive surface 24 appears in the fields of view of the imaging assemblies 60. A power adapter 62 provides the necessary operating power to the interactive board 22 when connected to a conventional AC mains power supply.

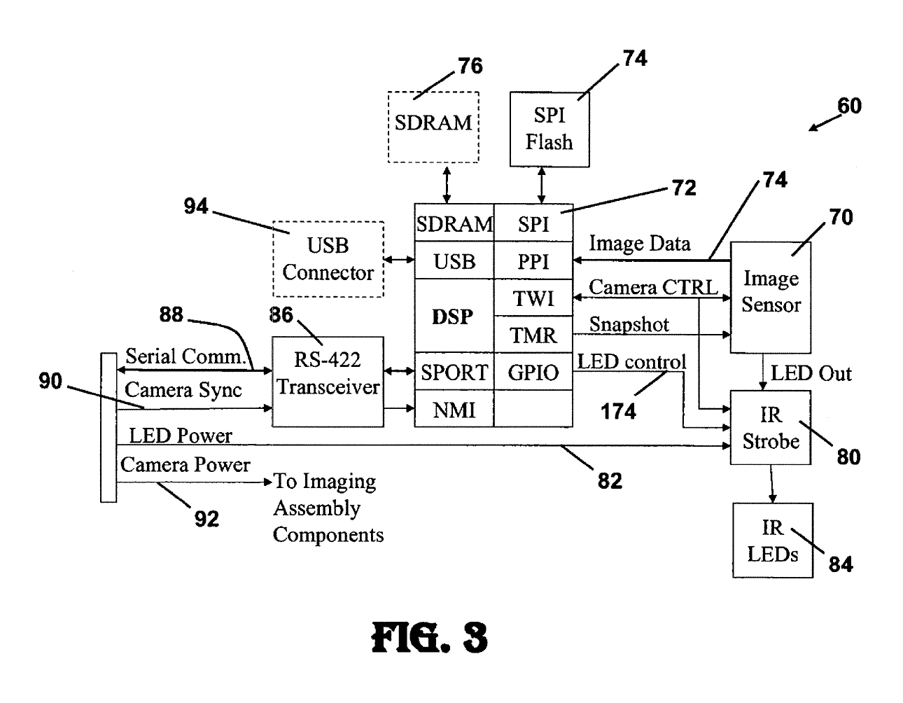

Turning now to FIG. 3, one of the imaging assemblies 60 is better illustrated. As can be seen, the imaging assembly 60 comprises an image sensor 70 such as that manufactured by Aptina (Micron) MT9V034 having a resolution of 752×480 pixels, fitted with a two element, plastic lens (not shown) that provides the image sensor 70 with a field of view of approximately 104 degrees. In this manner, the other imaging assemblies 60 are within the field of view of the image sensor 70 thereby to ensure that the field of view of the image sensor 70 encompasses the entire interactive surface 24.

A digital signal processor (DSP) 72 such as that manufactured by Analog Devices under part number ADSP-BF522 Blackfin or other suitable processing device, communicates with the image sensor 70 over an image data bus 74 via a parallel port interface (PPI). A serial peripheral interface (SPI) flash memory 74 is connected to the DSP 72 via an SPI port and stores the firmware required for image assembly operation. Depending on the size of captured image frames as well as the processing requirements of the DSP 72, the imaging assembly 60 may optionally comprise synchronous dynamic random access memory (SDRAM) 76 to store additional temporary data as shown by the dotted lines. The image sensor 70 also communicates with the DSP 72 via a two-wire interface (TWI) and a timer (TMR) interface. The control registers of the image sensor 70 are written from the DSP 72 via the TWI in order to configure parameters of the image sensor 70 such as the integration period for the image sensor 70.

In this embodiment, the image sensor 70 operates in snapshot mode. In the snapshot mode, the image sensor 70, in response to an external trigger signal received from the DSP 72 via the TMR interface that has a duration set by a timer on the DSP 72, enters an integration period during which an image frame is captured. Following the integration period after the generation of the trigger signal by the DSP 72 has ended, the image sensor 70 enters a readout period during which time the captured image frame is available. With the image sensor in the readout period, the DSP 72 reads the image frame data acquired by the image sensor 70 over the image data bus 74 via the PPI. The frame rate of the image sensor 70 in this embodiment is between about 900 and about 960 frames per second. The DSP 72 in turn processes image frames received from the image sensor 72 and provides pointer information to the master controller 50 at a reduced rate of approximately 120 points/sec. Those of skill in the art will however appreciate that other frame rates may be employed depending on the desired accuracy of pointer tracking and whether multi-touch and/or active pointer identification is employed.

Three strobe circuits 80 communicate with the DSP 72 via the TWI and via a general purpose input/output (GPIO) interface. The IR strobe circuits 80 also communicate with the image sensor 70 and receive power provided on LED power line 82 via the power adapter 52. Each strobe circuit 80 drives a respective illumination source in the form of an infrared (IR) light emitting diode (LED) 84a to 84c that provides infrared lighting over the interactive surface 24. Further specifics concerning the strobe circuits 80 and their operation are described in U.S. Provisional Application Ser. No. 61/294,825 to Akitt entitled “INTERACTIVE INPUT SYSTEM AND ILLUMINATION SYSTEM THEREFOR” filed on Jan. 13, 2010, the content of which is incorporated herein by reference in its entirety.

The DSP 72 also communicates with an RS-422 transceiver 86 via a serial port (SPORT) and a non-maskable interrupt (NMI) port. The transceiver 86 communicates with the master controller 50 over a differential synchronous signal (DSS) communications link 88 and a synch line 90. Power for the components of the imaging assembly 60 is provided on power line 92 by the power adapter 52. DSP 72 may also optionally be connected to a USB connector 94 via a USB port as indicated by the dotted lines. The USB connector 94 can be used to connect the imaging assembly 60 to diagnostic equipment.

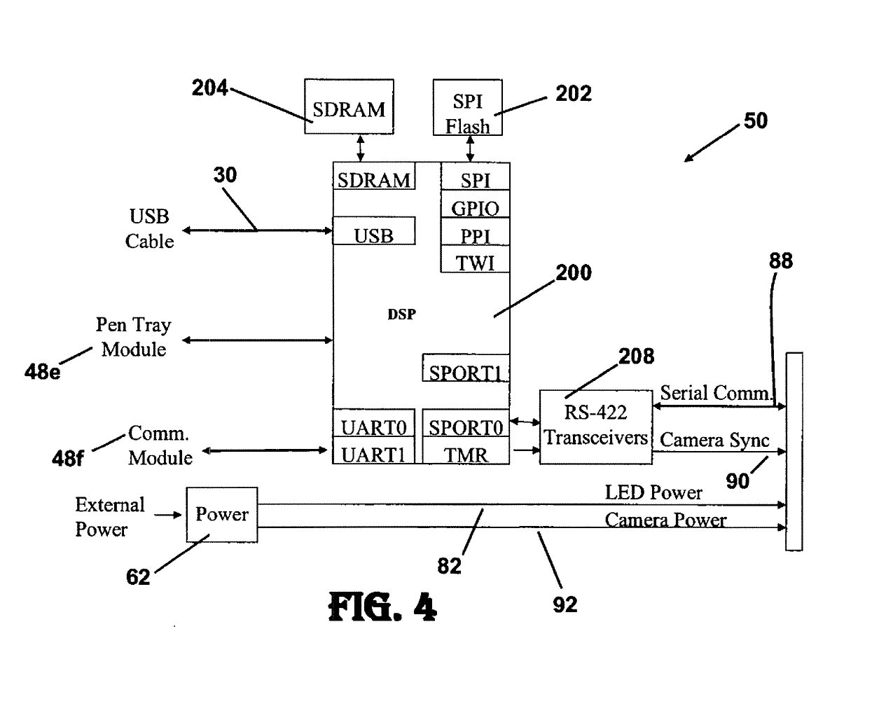

The master controller 50 better is illustrated in FIG. 4. As can be seen, master controller 50 comprises a DSP 200 such as that manufactured by Analog Devices under part number ADSP-BF522 Blackfin or other suitable processing device. A serial peripheral interface (SPI) flash memory 202 is connected to the DSP 200 via an SPI port and stores the firmware required for master controller operation. A synchronous dynamic random access memory (SDRAM) 204 that stores temporary data necessary for system operation is connected to the DSP 200 via an SDRAM port. The DSP 200 communicates with the general purpose computing device 28 over the USB cable 30 via a USB port. The DSP 200 communicates through its serial port (SPORT) with the imaging assemblies 60 via an RS-422 transceiver 208 over the differential synchronous signal (DSS) communications link 88. In this embodiment, as more than one imaging assembly 60 communicates with the master controller DSP 200 over the DSS communications link 88, time division multiplexed (TDM) communications is employed. The DSP 200 also communicates with the imaging assemblies 60 via the RS-422 transceiver 208 over the camera synch line 90. DSP 200 communicates with the tool tray accessory module 48e over an inter-integrated circuit I²C channel and communicates with the communications accessory module 48f over universal asynchronous receiver/transmitter (UART), serial peripheral interface (SPI) and I²C channels.

As will be appreciated, the architectures of the imaging assemblies 60 and master controller 50 are similar. By providing a similar architecture between each imaging assembly 60 and the master controller 50, the same circuit board assembly and common components may be used for both thus reducing the part count and cost of the interactive input system 20. Differing components are added to the circuit board assemblies during manufacture dependent upon whether the circuit board assembly is intended for use in an imaging assembly 60 or in the master controller 50. For example, the master controller 50 may require a SDRAM 76 whereas the imaging assembly 60 may not.

The general purpose computing device 28 in this embodiment is a personal or other suitable processing device computer comprising, for example, a processing unit, system memory (volatile and/or non-volatile memory), other non-removable or removable memory (e.g., a hard disk drive, RAM, ROM, EEPROM, CD-ROM, DVD, flash memory, etc.) and a system bus coupling the various computer components to the processing unit. The computer may also comprise a network connection to access shared or remote drives, one or more networked computers, or other networked devices.

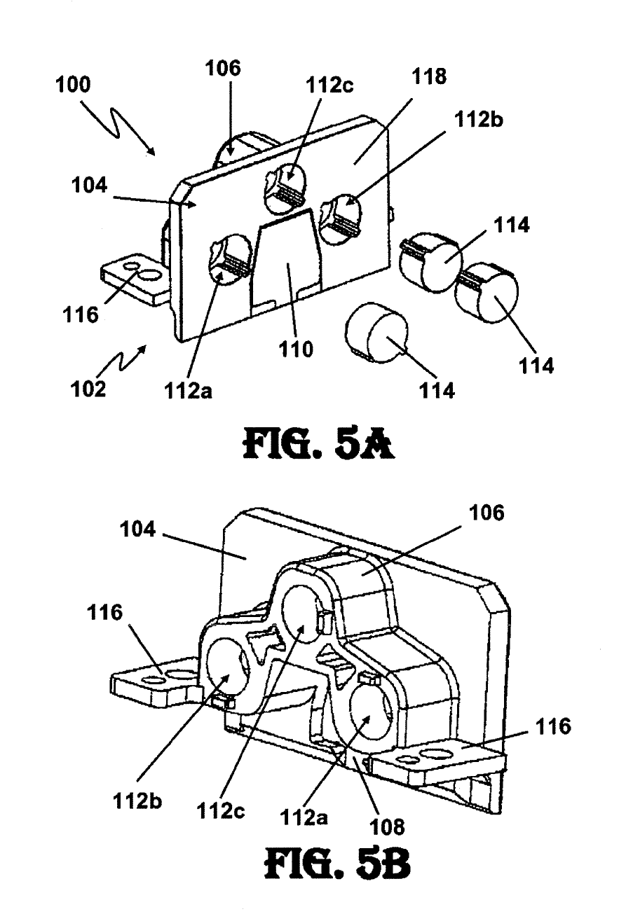

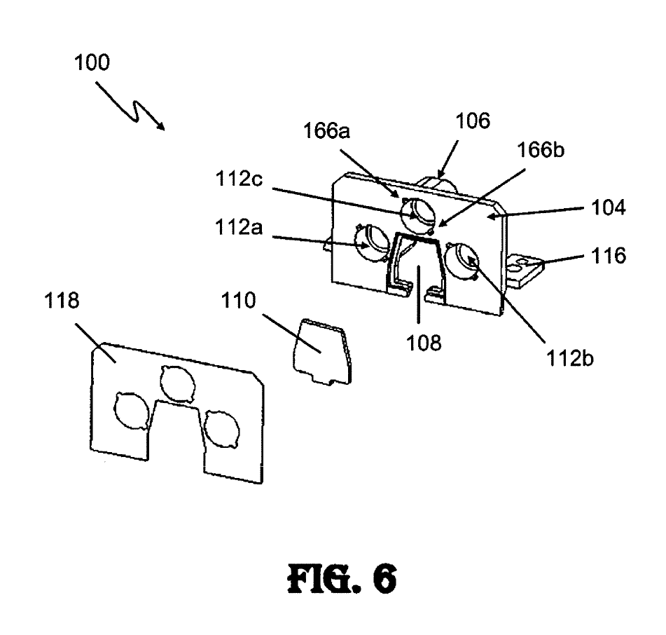

Turning now to FIGS. 5a, 5b and 6, a housing assembly 100 for one of the imaging assemblies 60 is best illustrated. As can be seen, the housing assembly 100 accommodates the image sensor 70 and its associated lens as well as the IR LEDs 84a to 84c. The housing assembly 100 comprises a polycarbonate housing body 102 having a front portion 104 and a rear portion 106 extending from the front portion. An imaging aperture 108 is centrally formed in the housing body 102 and accommodates an IR-pass/visible light blocking filter 110. The filter 110 has an IR-pass wavelength range of between about 830 nm and about 880 nm. The image sensor 70 and associated lens are positioned behind the filter 110 and oriented such that the field of view of the image sensor 70 looks through the filter 110 and generally across the interactive surface 24. The rear portion 106 is shaped to surround the image sensor 70. Three tubular passages 112a to 112c are formed through the housing body 102. Passages 112a and 112b are positioned on opposite sides of the filter 110 and are in general horizontal alignment with the image sensor 70. Passage 112c is centrally positioned above the filter 110. Each tubular passage receives a light source socket 114 that is configured to receive a respective one of the IR LEDs 84. In particular, the socket 114 received in passage 112a accommodates IR LED 84a, the socket 114 received in passage 112b accommodates IR LED 84b, and the socket 114 received in passage 112c accommodates IR LED 84c. Mounting flanges 116 are provided on opposite sides of the rear portion 106 to facilitate connection of the housing assembly 100 to the bezel 26 using suitable fasteners. A retro-reflective label 118 overlies the front surface of the front portion 104.

Housing assembly 100 is fabricated by injection molding using a single two-shot injection mold, whereby the housing body 102 and the filter 110 are each formed using a separate injection step into the mold. Additionally, in this embodiment, the application of the retro-reflective label 118 is performed between these injection steps. By virtue of this fabrication process, the housing body 102, the filter 110 and the retro-reflective label 118 are mechanically joined together. Housing assembly 100 therefore has what may be referred to as “integrated” construction. As will be appreciated, this integrated construction provides the advantage of eliminating the need to separately install the filter 110 into the housing body 102 during assembly, thereby simplifying the manufacturing process and reducing the cost of manufacturing.

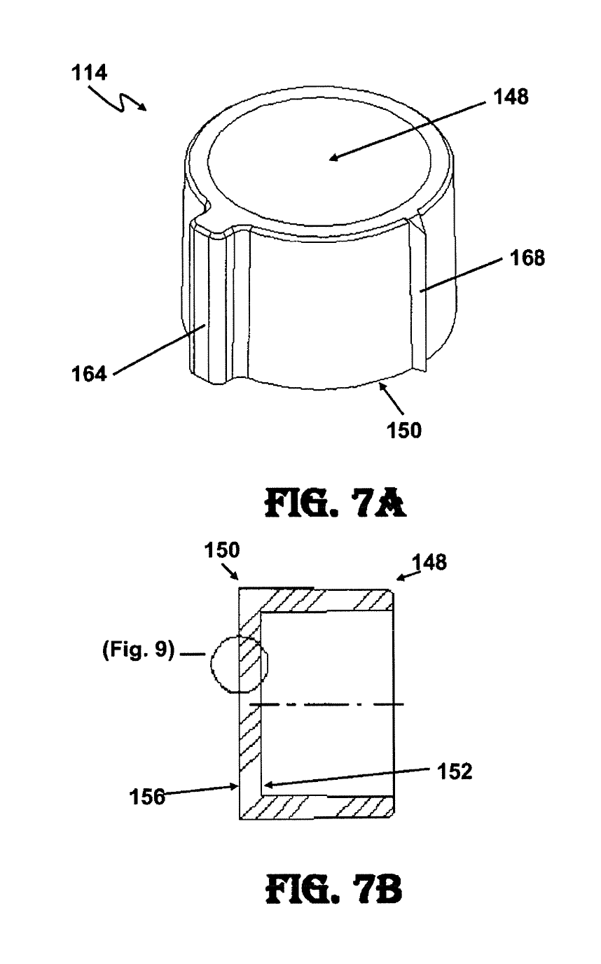

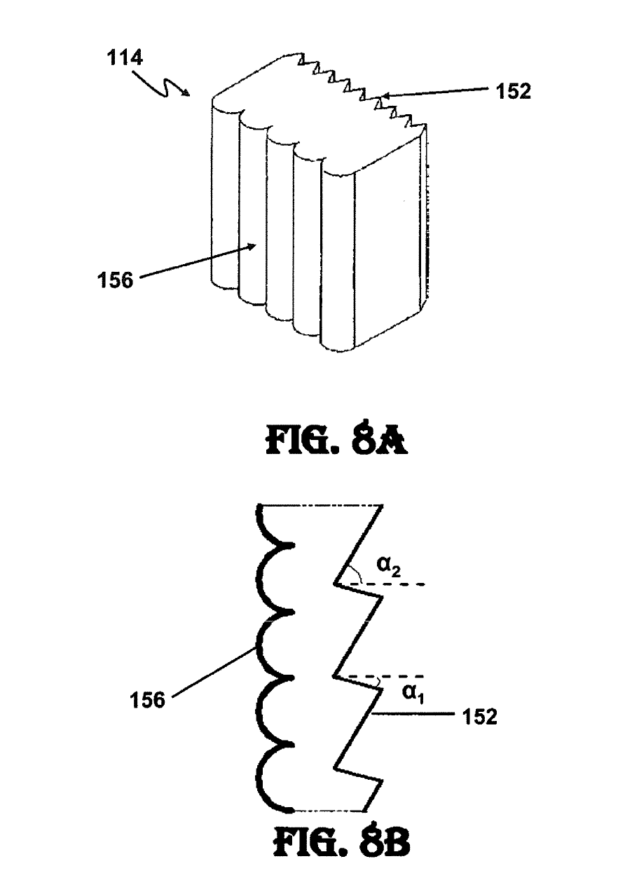

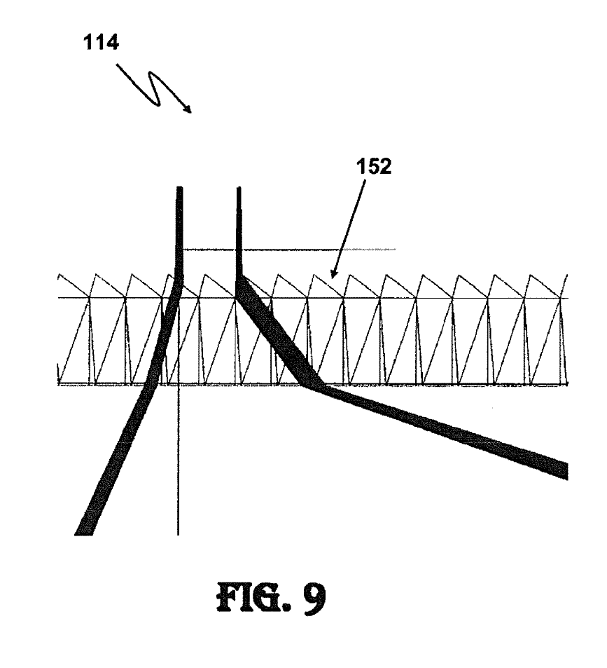

The construction of the sockets 114 may be more clearly seen in FIGS. 7 and 8. Each socket 114 is generally cylindrical and has a hollow construction with an open end 148 and a closed end 150. In this embodiment, each socket 114 is injection molded, and is formed of polycarbonate that is transmissive to infrared radiation. Each socket 114 accommodates a respective IR LED with the IR LED being oriented such that it emits infrared radiation through the closed end 150 of the socket. In this embodiment, two different optical surfaces are formed on the closed end 150 of the socket 114 during fabrication. On an inner surface of closed end 150 is a beam splitter layer 152. In this embodiment, beam splitter layer 152 comprises an array of longitudinal prisms, where the facets of the prisms are angled asymmetrically. Such asymmetric angling enables beam splitter layer 152 to direct light passing through closed end 150 into two different directions. In this embodiment, about 60 percent of the emitted infrared radiation is directed by beam splitter layer 152 in a first direction and the remaining about 40 percent of the emitted infrared radiation is directed by beam splitter layer 152 in a second direction, as illustrated in FIG. 9.

On an outer surface of closed end 150 is disposed a diffuser layer 156 comprising an array of rounded longitudinal protrusions. Diffuser layer 156 diffuses emitted infrared radiation exiting socket 114, and thereby causes each of the two portions of light separated by beam splitter layer 152 to be distributed more evenly within that general respective direction.

On an outer surface of each socket 114 is a longitudinal key rib 164 generally extending the length of socket 114. Key rib 164 is shaped to fit within one of two grooves 166a and 166b formed on the inner surface of each of the passages 112a to 112c of the housing body 102, as illustrated for passage 112c in FIG. 6. Key rib 164 cooperates with grooves 166a and 166b for enabling the socket 114 to be installed within its respective passage in either of two indexed positions defined by grooves 166a and 166b. Each socket 114 also has a crush rib 168 on its outer surface. Crush rib 168 has a smaller cross sectional area than key rib 164, and is sized and shaped to be compressed as socket 114 is press-fit into its respective passage during installation, thereby enabling socket 114 to be fixedly retained therein.

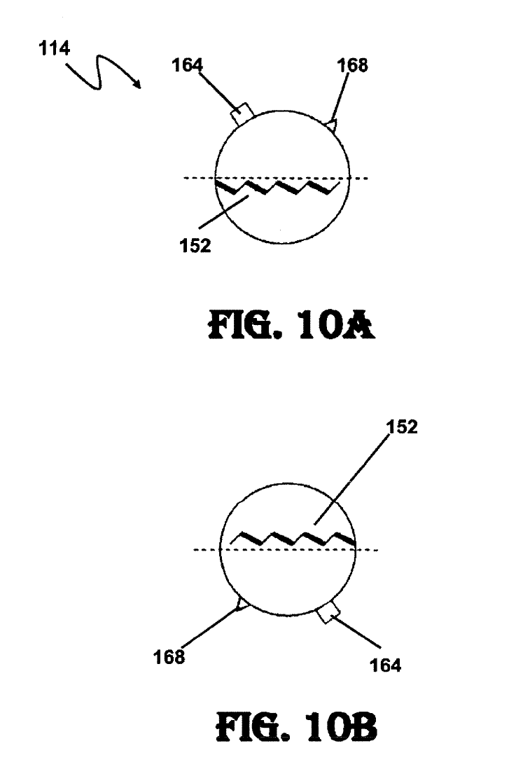

Such rotatability between these two indexed positions allows a greater portion (i.e., the about 60 percent portion) of infrared radiation to be directed either to the left or to the right of an axis normal to front surface 126 of housing assembly 100 for as desired. The orientation of the beam splitter layer 152 for each of these two indexed positions is illustrated schematically in FIGS. 10a and 10b. By installing all three sockets 114 in the same orientation, a greater portion of the total infrared radiation emitted from housing assembly 100 will be directed in one of these two directions.

As will be appreciated, the feature of rotatability of sockets 114 allows the housing assembly 100 to be configured so as to illuminate the bezel 26 substantially evenly. As the bezel surrounding interactive surface 24 is generally rectangular in shape, the lengths of the two bezel segments in the field of view of each image sensor 70 will differ. By configuring the sockets 114 such that a greater amount of infrared radiation emitted from imaging assembly 60 is directed onto the longer of the two bezel segments, the distribution of infrared radiation over the combined length of the bezel segments is more even, and the bezel 26 as seen by the image sensor 70 will therefore appear to be more evenly illuminated.

Additionally, the rotatability of the sockets 114 enables the housing assembly 100 to be configured for “right-handed” or “left-handed” illumination of the bezel, as needed, for positioning of the housing assembly 100 on any corner position of interactive surface 24. For example, if housing assembly 100 is positioned in the upper right corner of interactive surface 24, it is required that the greater portion of infrared radiation be directed to the left of the normal of front surface 126, as the length of the bottom bezel segment is greater than that of the side bezel segment. As will be appreciated, this allows the housing assembly 100 to be adapted in a facile manner for positioning at any corner of the interactive board 22, and provides the advantage of allowing identical parts to be used for all positions, thereby reducing manufacturing costs.

During operation, the DSP 200 of the master controller 50 outputs synchronization signals that are applied to the synch line 90 via the transceiver 208. Each synchronization signal applied to the synch line 90 is received by the DSP 72 of each imaging assembly 60 via transceiver 86 and triggers a non-maskable interrupt (NMI) on the DSP 72. In response to the non-maskable interrupt triggered by the synchronization signal, the DSP 72 of each imaging assembly 60 ensures that its local timers are within system tolerances and if not, corrects its local timers to match the master controller 50. Using one local timer, the DSP 72 initiates a pulse sequence via the snapshot line that is used to condition the image sensor 70 to the snapshot mode and to control the integration period and frame rate of the image sensor 70 in the snapshot mode. The DSP 72 also initiates a second local timer that is used to provide output on the LED control line 174 so that the IR LEDs 84a to 84c are properly powered during the image frame capture cycle.

In response to the pulse sequence output on the snapshot line, the image sensor 70 of each imaging assembly 60 acquires image frames at the desired image frame rate. In this manner, image frames captured by the image sensor 70 of each imaging assembly can be referenced to the same point of time allowing the position of pointers brought into the fields of view of the image sensors 70 to be accurately triangulated. Also, by distributing the synchronization signals for the imaging assemblies 60, electromagnetic interference is minimized by reducing the need for transmitting a fast clock signal to each image assembly 60 from a central location. Instead, each imaging assembly 60 has its own local oscillator (not shown) and a lower frequency signal (e.g., the point rate, 120 Hz) is used to keep the image frame capture synchronized.

During image frame capture, the DSP 72 of each imaging assembly 60 also provides output to the strobe circuits 80 to control the switching of the IR LEDs 84a to 84c so that the IR LEDs are illuminated in a given sequence that is coordinated with the image frame capture sequence of each image sensor 70. In particular, in the sequence the first image frame is captured by the image sensor 70 when the IR LED 84c is fully illuminated in a high current mode and the other IR LEDs are off. The next image frame is captured when all of the IR LEDs 84a to 84c are off. Capturing these successive image frames with the IR LED 84c on and then off allows ambient light artifacts in captured image frames to be cancelled by generating difference image frames as described in U.S. Application Publication No. 2009/0278794 to McReynolds, et al., assigned to SMART Technologies ULC, the content of which is incorporated herein by reference in its entirety. The third image frame is captured by the image sensor 70 when only the IR LED 84a is on and the fourth image frame is captured by the image sensor 70 when only the IR LED 84b is on. Capturing these image frames allows pointer edges and pointer shape to be determined as described in U.S. Provisional Application No. 61/294,832 to McGibney, et al., entitled “INTERACTIVE INPUT SYSTEM AND ILLUMINATION SYSTEM THEREFOR” filed on Jan. 14, 2010, the content of which is incorporated herein by reference in its entirety. The strobe circuits 80 also control the IR LEDs 84a to 84c to inhibit blooming and to reduce the size of dark regions in captured image frames that are caused by the presence of other imaging assemblies 60 within the field of view of the image sensor 70 as will now be described.

During the image capture sequence, when each IR LED 84 is on, the IR LED floods the region of interest over the interactive surface 24 with infrared illumination. Infrared illumination that impinges on the retro-reflective bands of bezel segments 40, 42, 44 and 46 and on the retro-reflective labels 118 of the housing assemblies 100 is returned to the imaging assemblies 60. As a result, in the absence of a pointer, the image sensor 70 of each imaging assembly 60 sees a bright band having a substantially even intensity over its length together with any ambient light artifacts. When a pointer is brought into proximity with the interactive surface 24, the pointer occludes infrared illumination reflected by the retro-reflective bands of bezel segments 40, 42, 44 and 46 and/or the retro-reflective labels 118. As a result, the image sensor 70 of each imaging assembly 60 sees a dark region that interrupts the bright band 160 in captured image frames. The reflections of the illuminated retro-reflective bands of bezel segments 40, 42, 44 and 46 and the illuminated retro-reflective labels 118 appearing on the interactive surface 24 are also visible to the image sensor 70.

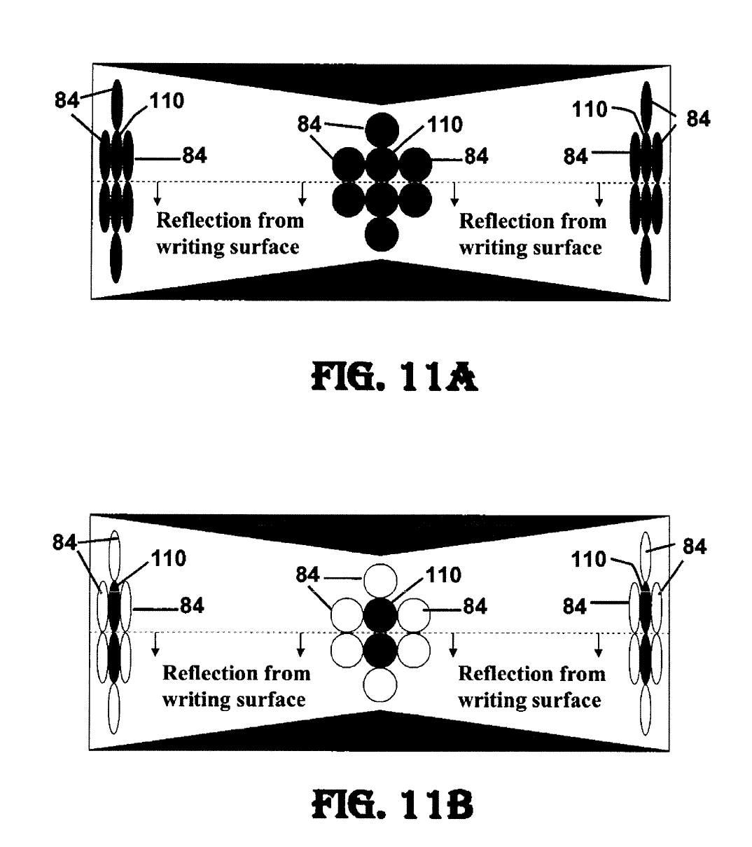

FIG. 11a shows an exemplary image frame captured by the image sensor 70 of one of the imaging assemblies 60 when the IR LEDs 84 associated with the other imaging assemblies 60 are off during image frame capture. As can be seen, the IR LEDs 84a to 84c and the filter 110 of the other imaging assemblies 60 appear as dark regions that interrupt the bright band. These dark regions can be problematic as they can be inadvertently recognized as pointers.

To address this problem, when the image sensor 70 of one of the imaging assemblies 60 is capturing an image frame, the strobe circuits 80 of the other imaging assemblies 60 are conditioned by the DSPs 72 to a low current mode. In the low current mode, the strobe circuits 80 control the operating power supplied to the IR LEDs 84a to 84c so that they emit infrared lighting at an intensity level that is substantially equal to the intensity of infrared illumination reflected by the retro-reflective bands on the bezel segments 40, 42, 44 and 46 and by the retro-reflective labels 118. FIG. 11b shows an exemplary image frame captured by the image sensor 70 of one of the imaging assemblies 60 when the IR LEDs 84a to 84c associated with the other imaging assemblies 60 are operated in the low current mode. As a result, the size of each dark region is reduced. Operating the IR LEDs 84a to 84c in this manner also inhibits blooming (i.e., saturation of image sensor pixels) which can occur if the IR LEDs 84a to 84c of the other imaging assemblies 60 are fully on during image frame capture. The required levels of brightness for the IR LEDs 84a to 84c in the low current mode are related to the distance between the image sensor 70 and the opposing bezel segments 40, 42, 44, and 46. Generally, lower levels of brightness are required as the distance between the image sensor 70 and the opposing bezel segments 40, 42, 44, and 46 increases due to the light loss within the air as well as inefficient distribution of light from each IR LED towards the bezel segments 40, 42, 44, and 46.

The sequence of image frames captured by the image sensor 70 of each imaging assembly 60 is processed by the DSP 72 to identify each pointer in each image frame and to obtain pointer shape and contact information as described in above-incorporated U.S. Provisional Application Ser. No. 61/294,832 to McGibney, et al. The DSP 72 of each imaging assembly 60 in turn conveys the pointer data to the DSP 200 of the master controller 50. The DSP 200 uses the pointer data received from the DSPs 72 to calculate the position of each pointer relative to the interactive surface 24 in (x,y) coordinates using well known triangulation as described in above-incorporated U.S. Pat. No. 6,803,906 to Morrison. This pointer coordinate data along with pointer shape and pointer contact status data is conveyed to the general purpose computing device 28 allowing the image data presented on the interactive surface 24 to be updated.

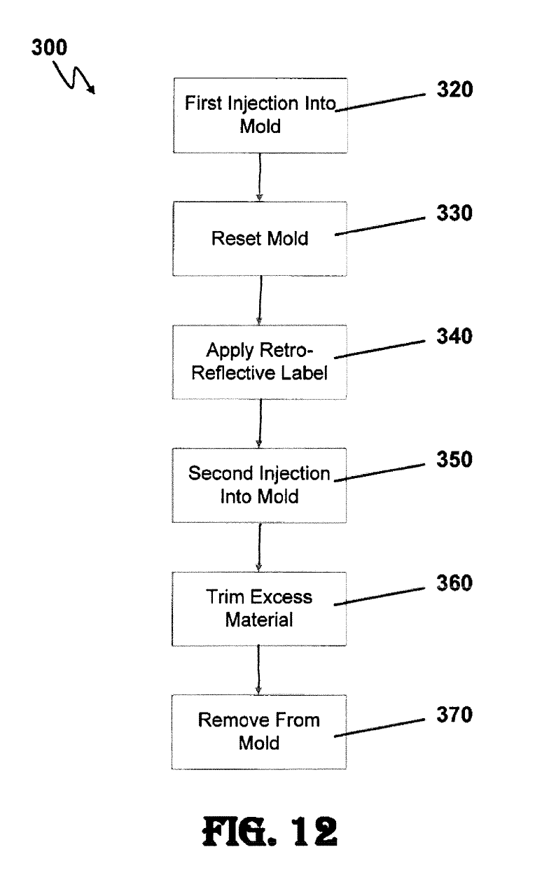

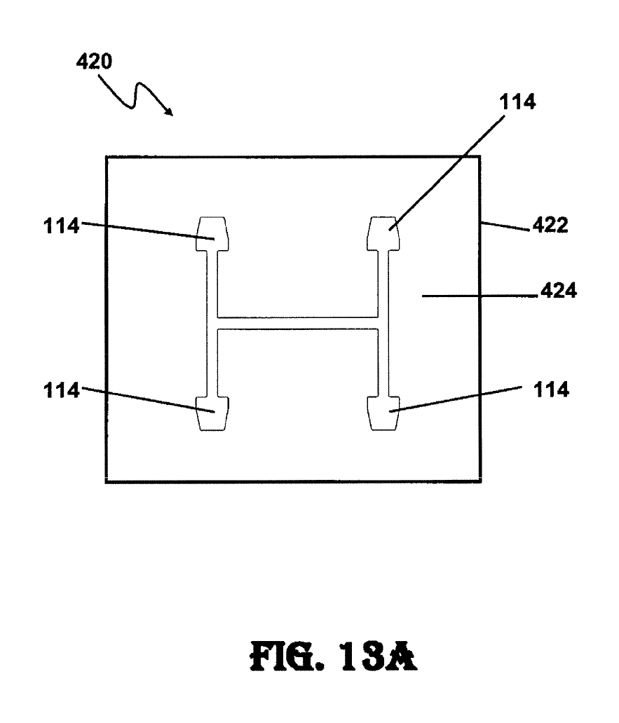

The steps performed to fabricate the housing assembly 100 are shown in FIG. 12, and are generally indicated by reference numeral 300. Fabrication sequence 300 involves polymer injection molding using a single two-shot sequence. Two-shot injection molding processes are known and have been described elsewhere, such as in U.S. Pat. No. 6,790,027 to Callen, et al., for example. Filter 110 is first formed by injecting a first injection into the mold (step 320). The first injection uses a first material which, in this embodiment, is a polycarbonate that is transmissive to infrared radiation. Following the first injection 320, the injection mold is reset (step 330) in preparation for subsequent steps. This step may include a sequence of substeps such as, for example, opening the mold by separating the mold platens, ejecting the runners, and rotating one of the platens by 180 degrees; however this step is not limited to these substeps. Once the mold has been reset, the retro-reflective label 118 is then applied (step 340). Here, a continuous roll of retro-reflective material which has been pre-cut to define a series of retro-reflective labels 118 is brought into proximity and aligned with one of the platens of the separated mold. A retro-reflective label 118 is then transferred from the roll to the platen, and the mold is then closed. Housing body 102 is then formed by injecting a second injection into the mold (step 350), and with filter 110 and retro-reflective label 118 both present in the mold. The second injection uses a second material which, in this embodiment, is a polycarbonate. As will be appreciated, by using a second injection while filter 110 and retro-reflective label 118 are still in the mold, the housing body 102 is formed around the filter 110 so as to encompass the filter 110. Following the second injection 350, the housing assembly 100 now present in the mold is trimmed to remove excess material (step 360). Following trimming, the housing assembly 100 is removed from the mold (step 370).

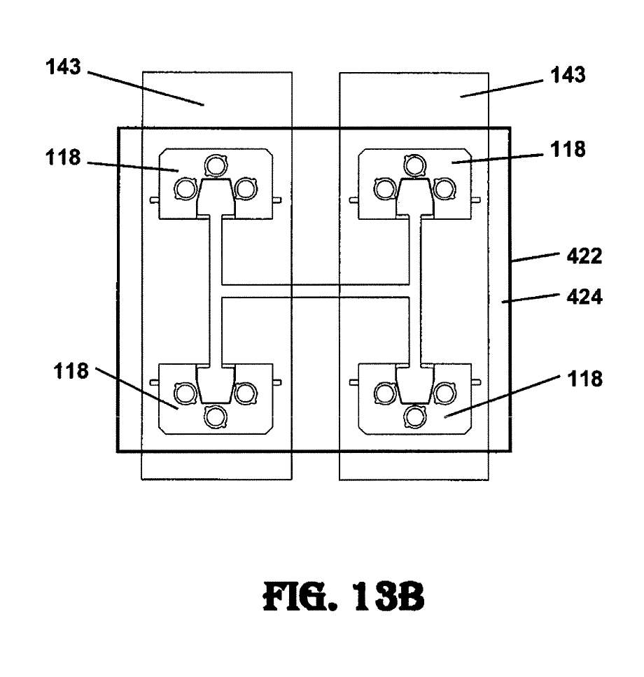

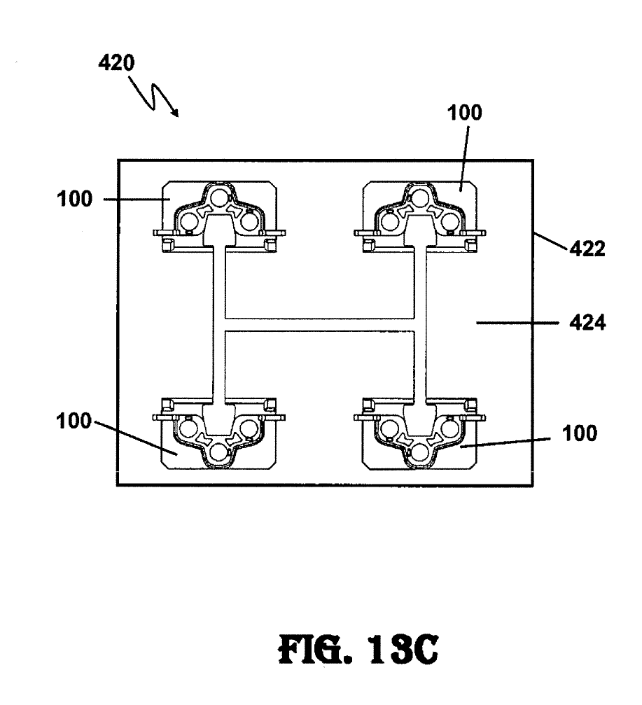

FIGS. 13a to 13c illustrate various stages of the mold used to perform the fabrication sequence. In the embodiment illustrated, fabrication sequence 300 is carried out using a two-shot injection mold 420 that comprises a first platen 422 having a platen surface 424 interfacing with a corresponding platen surface of a second platen. The injection mold 420 defines a set of four injection mold cavities linked by a network of runners, as will be understood by those of skill in the art. At the end of the first injection (step 320), a set of four filters 114 is formed in the mold 420, as illustrated in FIG. 13a. For application of the labels 118 (step 340), two continuous rolls 143 of retro-reflective material having labels 118 are brought into proximity and aligned with the platen surface 424 of the first platen 422, as illustrated in FIG. 10b. A set of four labels 118 is then transferred to the platen surface 422. At the end of the second injection (step 350), a set of four housing assemblies 102 is formed around both the filters 114 and the retro-reflective labels 118 in the mold 420 to form a set of four housing assemblies 100, as illustrated in FIG. 10c.

Although as described above, the retro-reflective label 118 is applied during the fabrication process between the first injection step and the second injection step, in other embodiments the retro-reflective label may alternatively be applied after the second injection step. In other embodiments, the retro-reflective label may alternatively be applied after the housing assembly has been removed from the mold.

Although as described above, the beam splitter layer directs about 60 percent of infrared radiation in a first direction and the remaining about 40 percent of infrared radiation in a second direction, the beam splitter layer is not limited to these values and in other embodiments the beam splitter layer may alternatively direct other percentages of infrared radiation in the two directions. This may be useful, for example, for use with interactive surfaces of different aspect ratios.

Although as described above, the diffuser layer and the beam splitter layer are formed integrally on the light source socket during the fabrication of the light source socket by injection molding, in other embodiments, either the diffuser layer, the beam splitter layer, or both may be alternatively formed on the socket by other processes, such as by adhesion or by deposition, for example.

Although as described above, each passage of the housing assembly has two grooves for each cooperating with a key rib of the respective socket, in other embodiments, each passage may alternatively have fewer or more grooves.

Although as described above, each passage of the housing assembly has grooves for each cooperating with a key rib of the sockets, in other embodiments, the sockets may alternatively have one or more grooves and the passages of the housing assembly may alternatively have one or more key ribs. In still other embodiments, the sockets and the passages may alternatively have neither grooves nor key ribs, and instead may be configured to allow the sockets to be rotated within the passages in a non-indexed manner, and by any degree of rotation.

In the embodiments described above, a short-throw projector is used to project an image onto the interactive surface 24. As will be appreciated other front projection devices or alternatively a rear projection device may be used to project the image onto the interactive surface 24. Rather than being supported on a wall surface, the interactive board 22 may be supported on an upstanding frame or other suitable support. Still alternatively, the interactive board 22 may engage a display device such as for example a plasma television, a liquid crystal display (LCD) device etc. that presents an image visible through the interactive surface 24.

Although a specific processing configuration has been described, those of skill in the art will appreciate that alternative processing configurations may be employed. For example, one of the imaging assemblies may take on the master controller role. Alternatively, the general purpose computing device may take on the master controller role.

Although embodiments have been described, those of skill in the art will appreciate that variations and modifications may be made with departing from the spirit and scope thereof as defined by the appended claims.

What is claimed is:

1. A housing assembly for an imaging assembly, the housing assembly comprising:
a housing body comprising at least one passage for accommodating a respective light socket; and
a filter integrated with the housing body through which an image sensor looks.

2. The housing assembly of claim 1, wherein the housing body comprises a plurality of passages, each passage accommodating a respective light socket.

3. The housing assembly of claim 2, wherein two of said passages are positioned on opposite sides of said filter.

4. The housing assembly of claim 3, wherein one of said passages is positioned above said filter.

5. The housing assembly of claim 4, wherein said one passage is centrally positioned above said filter.

6. The housing assembly of claim 4, wherein said filter is an infrared pass filter.

7. The housing assembly of claim 6, wherein said infrared pass filter has a pass wavelength range of between about 830 nm and 880 nm.

8. The housing assembly of claim 1, wherein said filter is an infrared pass filter.

9. The housing assembly of claim 7, wherein said infrared pass filter has a pass wavelength range of between about 830 nm and 880 nm.

10. The housing assembly of claim 1, further comprising a retro-reflective label disposed on a forward surface of the housing body.

11. The housing assembly of claim 6, further comprising a retro-reflective label disposed on a forward surface of the housing body.

12. The housing assembly of claim 8, further comprising a retro-reflective label disposed on a forward surface of the housing body.

13. The housing assembly of claim 1, wherein the filter and the housing body are formed of injection moldable materials.

14. The housing assembly of claim 1, wherein the socket comprises a closed end through which radiation emitted by a light source accommodated by said socket passes.

15. The housing assembly of claim 14, wherein the closed end comprises at least one of a beam splitter layer and a diffuser layer.

16. The housing assembly of claim 15, wherein the closed end comprises both a beam splitter layer and a diffuser layer.

17. The housing assembly of claim 6, wherein the closed end comprises at least one of a beam splitter layer and a diffuser layer.

18. The housing assembly of claim 17, wherein the closed end comprises both a beam splitter layer and a diffuser layer.

19. The housing assembly of claim 8, wherein the closed end comprises at least one of a beam splitter layer and a diffuser layer.

20. The housing assembly of claim 19, wherein the closed end comprises both a beam splitter layer and a diffuser layer.

21. The housing assembly of claim 10, wherein the closed end comprises at least one of a beam splitter layer and a diffuser layer.

22. The housing assembly of claim 21, wherein the closed end comprises both a beam splitter layer and a diffuser layer.

23. The housing assembly of claim 1, wherein the socket is rotatable within the passage.

24. The housing assembly of claim 23, wherein the socket is rotatable within the passage between indexed positions.

25. The housing assembly of claim 24, wherein the socket and passage carry mating formations.

26. The housing assembly of claim 25, wherein the mating formations comprise a plurality of grooves and a rib.

27. The housing assembly of claim 26, wherein the grooves are formed in a wall surrounding the passage and the rib is carried by the socket.

28. A method of fabricating a housing, assembly of an imaging assembly for use with an interactive input system, the method comprising:
forming a filter in a mold using a first injection; and
forming a housing body around the filter in the mold using a second injection.

29. The method of claim 28, further comprising resetting the mold prior to the step of forming the housing body.

30. The method of claim 28, wherein the filter forming comprises molding the filter using a first material and the housing body forming comprises molding the filter body using a second material.

31. The method of claim 30, wherein the first and second materials are polycarbonate.

32. The method of claim 28, further comprising applying a label to a forward surface and the housing body.

33. The method of claim 29, further comprising applying a label to a formed surface and the housing body.

34. The method of claim 28, wherein the filter forming and housing body forming are performed at a plurality of injection molding locations simultaneously.

35. The method of claim 32, wherein the filter forming and housing body forming are performed at a plurality of injection molding locations simultaneously.
